(19) United States
(12) Patent Application Publication
(10) Pub. No.: US 2022/0097053 A1
(43) Pub. Date: Mar. 31, 2022

(54) FLUID HANDLING DEVICE

(71) Applicant: Enplas Corporation, Saitama (JP)

(72) Inventor: Nobuya SUNAGA, Saitama (JP)

(73) Assignee: Enplas Corporation, Saitama (JP)

(21) Appl. No.: 17/481,606

(22) Filed: Sep. 22, 2021

(30) Foreign Application Priority Data
Sep. 30, 2020 (JP) 2020-165250
Dec. 28, 2020 (JP) 2020-218772

(51) Int. Cl. B01L 3/00

(52) U.S. Cl. CPC B01L 3/502715; B01L 3/502738; B01L 3/502769; B01L 2200/0647; B01L 2400/0409; B01L 2400/0638; B01L 2300/0681

(57) ABSTRACT

A fluid handling device according to an embodiment of the present invention is a fluid handling device that includes a substrate and a film bonded to the substrate and that is configured to process a fluid, the fluid handling device including: a channel; a well connected to the channel; a rotary membrane valve disposed between the channel and the well; and a rotary membrane pump connected to the channel. For example, in the fluid handling device according to the embodiment of the present invention, a filter is disposed in the well or between the well and the rotary membrane valve for separating a blood cell component.

### CROSS REFERENCE TO RELATED APPLICATIONS

This application is entitled to and claims the benefit of Japanese Patent Application No. 2020-165250, filed on Sep. 30, 2020, and No. 2020-218772, filed on Dec. 28, 2020, the disclosure of which including the specification, drawings and abstract is incorporated herein by reference in its entirety.

### TECHNICAL FIELD

The present invention relates to a fluid handling device.

### BACKGROUND ART

In recent years, microwell plates, channel chips, and the like have been used for analysis of cells, proteins, nucleic acids, and the like. Advantageously, the microwell plates and channel chips require only a small amount of reagents and samples for the analysis, and are expected to be used in various applications such as clinical tests, food tests, and environmental tests.

For example, Patent Literature (hereinafter referred to as “PTL”) 1 discloses that a microwell plate (sample processing plate) is used to extract DNA using magnetic beads from a sample such as blood.

### CITATION LIST

### Patent Literature

PTL 1
Japanese Patent Application Laid-Open No. 2018-54619

### SUMMARY OF INVENTION

### Technical Problem

The present inventors have considered that a fluid handling device can be used in a versatile manner with various modifications for providing specific functions, while having a common structure.

An object of the present invention is to provide a fluid handling device having a rotary membrane valve and a rotary membrane pump, and further having a specific function.

### Solution to Problem

A fluid handling device according to a first invention of the present application is a fluid handling device that includes a substrate and a film bonded to the substrate and that is configured to process a fluid, the fluid handling device including: a channel; a well connected to the channel; a rotary membrane valve disposed between the channel and the well; and a rotary membrane pump connected to the channel, in which the substrate or the film has a structure for pulverizing an introduced sample at a position corresponding to the rotary membrane pump.

A fluid handling device according to a second invention of the present application is a fluid handling device that includes a substrate and a film bonded to the substrate and that is configured to process a fluid, the fluid handling device including: a channel; a well connected to the channel; a rotary membrane valve disposed between the channel and the well; and a rotary membrane pump connected to the channel; and a filter disposed in the well or between the well and the rotary membrane valve for separating a blood cell component.

A fluid handling device according to a third invention of the present application is a fluid handling device that includes a substrate and a film bonded to the substrate and that is configured to process a fluid, the fluid handling device including: a channel; a well connected to the channel; a rotary membrane valve disposed between the channel and the well; a rotary membrane pump connected to the channel; a gel disposed in the channel; and a pair of electrodes disposed to be capable of applying a voltage to the gel.

A fluid handling device according to a fourth invention of the present application is a fluid handling device that includes a substrate and a film bonded to the substrate and that is configured to process a fluid, the fluid handling device including: a channel; a well connected to the channel; a rotary membrane valve disposed between the channel and the well; and a rotary membrane pump connected to the channel, in which the channel includes a fluorescence detection section that is a space for accommodating the fluid on which detection of fluorescence is performed, and the fluorescence detection section is deeper than a portion of the channel other than the fluorescence detection section.

A fluid handling device according to a fifth invention of the present application is a fluid handling device that includes a substrate and a film bonded to the substrate and that is configured to process a fluid, the fluid handling device including: a channel; a well connected to the channel; a rotary membrane valve disposed between the channel and the well; and a rotary membrane pump connected to the channel, in which the channel includes a branch portion and a liquid surface detection section that is disposed at a predetermined distance from the branch portion and at which arrival of a liquid surface is sensed, and a cross-sectional area of a portion of the channel between the branch portion and the liquid surface detection section is smaller than a cross-sectional area of a portion of the channel not situated between the branch portion and the liquid surface detection section.

A fluid handling device according to a sixth invention of the present application is a fluid handling device that includes a substrate and a film bonded to the substrate and that is configured to process a fluid, the fluid handling device including: a channel; a well connected to the channel; a rotary membrane valve disposed between the channel and the well; and a rotary membrane pump connected to the channel, in which the rotary membrane pump includes an agar medium disposed between the substrate and the film.

A fluid handling device according to a seventh invention of the present application is a fluid handling device that includes a substrate and a film bonded to the substrate and that is configured to process a fluid, the fluid handling device including: a channel; a well connected to the channel; a rotary membrane valve disposed between the channel and the well; and a rotary membrane pump connected to the channel, in which a surface of the substrate exposed in the channel or the well or a surface of the film exposed in the channel or the well includes an immobilization surface for immobilization of an antibody or an antigen, and the immobilization surface of the substrate or the film has a surface physical property different from that of a surface other than the immobilization surface.

### Advantageous Effects of Invention

According to the present invention, it is possible to provide various fluid handling devices having a common structure of a rotary membrane valve and a rotary membrane pump, and further having specific functions.

### BRIEF DESCRIPTION OF DRAWINGS

FIG. 1A is a sectional view illustrating a configuration of a fluid handling system;

FIG. 1B is a bottom view of a fluid handling device according to Embodiment 1;

FIG. 2A illustrates a filter of a fluid handling device according to Embodiment 2;

FIGS. 2B and 2C are explanatory views of a liquid detection section;

FIGS. 3A, 3B, 3C and 3D illustrate a configuration of a fluid handling device according to Embodiment 3;

FIG. 4 illustrates a configuration of a fluid handling device according to Embodiment 4; and

FIG. 5 illustrates a configuration of a fluid handling device according to Embodiment 5.

### DESCRIPTION OF EMBODIMENTS

Hereinafter, embodiments of the present invention will be described in detail with reference to the drawings.

[Configuration of Fluid Handling Device]

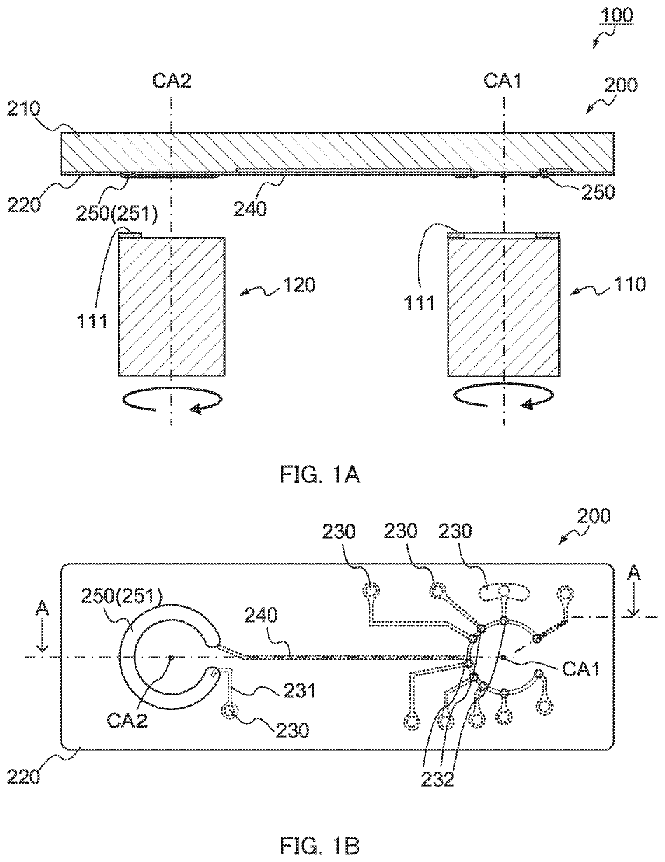

FIG. 1A is a sectional view illustrating a configuration of fluid handling system 100. FIG. 1B is a bottom view of fluid handling device (channel chip) 200 according to the present embodiments. FIG. 1B illustrates below-described fluid handling device 200 according to Embodiment 1, in which a channel inside and the like are illustrated by a broken line. The section of fluid handling device 200 in FIG. 1A is a sectional view taken along line A-A in FIG. 1B.

As illustrated in FIG. 1A, fluid handling system 100 controls the movement of a fluid inside fluid handling device 200 disposed at a predetermined position. Fluid handling device 200 includes the channel, a plurality of rotary membrane valves 232, and rotary membrane pump 251. Diaphragm portion 250 of rotary membrane valves 232 and diaphragm portion 250 of rotary membrane pump 251 are pressed respectively by rotary members (first rotary member 110 or second rotary member 120) so that the movement of the fluid in the channel is controlled.

Fluid handling device 200 includes substrate 210 and film 220 bonded to substrate 210. Further, in the present embodiments, fluid handling device 200 includes common channel 240, a plurality of wells 230 connected to common channel 240, a plurality of rotary membrane valves 232 disposed between common channel 240 and the plurality of wells 230, and rotary membrane pump 251 connected to common channel 240, and is capable of processing a fluid.

First rotary member 110 is rotated about first central axis CA1 by an external drive mechanism (not illustrated). Second rotary member 120 is rotated about second central axis CA2 by an external drive mechanism (not illustrated).

Fluid handling device 200 includes substrate 210 and film 220. The channel (common channel 240) is formed between substrate 210 and film 220. For example, a groove serving as the channel, through holes serving as the wells (inlets or outlets of the fluid), and the like are formed in substrate 210. Film 220 is bonded to one surface of substrate 210 to close the opening of the groove and one openings of the through holes. In addition, a plurality of diaphragm portions 250 are formed on a part of film 220. Film 220 may be a single layer film or a laminate of a plurality of films. For example, film 220 may be a laminate of a first film and a second film.

For example, two channels are formed by closing, with film 220, openings of two grooves formed in substrate 210. A portion of film 220 located on a partition wall (a portion of substrate 210 between the two grooves) formed between these two channels is caused to be deflected on the side opposite to substrate 210 to form diaphragm portion 250, whereby a valve (diaphragm valve or membrane valve) having diaphragm portion 250 between the two channels can be formed (see diaphragm portion 250 on the right side in FIGS. 1A and 1B). When diaphragm portion 250 of this valve is pressed, the valve is closed and the fluid cannot move between the two channels. On the other hand, when diaphragm portion 250 of the valve is released from pressing, the valve opens, allowing the fluid to move between the two channels. In the present specification, this valve is called a “rotary membrane valve” because this valve is controlled by using a rotary member (first rotary member 110).

In addition, a portion of film 220 located in an arc-shaped region of substrate 210 in which no groove is formed is caused to be deflected on the side opposite to substrate 210 to serve as diaphragm portion 250, whereby rotary membrane pump 251 having diaphragm portion 250 can be formed (see diaphragm portion 250 on the left side in FIGS. 1A and 1B). When this rotary membrane pump 251 is pressed along an arc in a direction from one end to the other end, the fluid between substrate 210 and diaphragm portion 250 can be moved.

Each of first rotary member 110 and second rotary member 120 has convex portion 111 for pressing diaphragm portion 250.

First rotary member 110 rotates about first central axis CA1, second rotary member 120 rotates about second central axis CA2. By rotation of each of first rotary member 110 and second rotary member 120, convex portion 111 comes into or goes out of contact with diaphragm portion 250. For example, the valve closes when convex portion 111 comes into contact with diaphragm portion 250 of the valve, and the valve opens when convex portion 111 is away from diaphragm portion 250 of the valve. Further, when convex portion 111 presses rotary membrane pump 251 in the direction from one end to the other end (e.g., clockwise), the fluid moves from one end to the other end, and when convex portion 111 presses rotary membrane pump 251 in the direction from the other end to one end (e.g., counterclockwise), the fluid moves from the other end to one end. This controls the movement of the fluid in fluid handling device 200. Note that, in the illustration of FIG. 1A, fluid handling device 200 is separated from first rotary member 110 and second rotary member 120 for the sake of explanation.

Embodiments 1 to 7 will be described below as application examples of fluid handling device 200.

### Embodiment 1

A description will be given of Embodiment 1 that is fluid handling device 200 having a function of pulverizing an introduced sample.

As described above, fluid handling device 200 according to Embodiment 1 includes common channel 240, a plurality of wells 230 connected to common channel 240, a plurality of rotary membrane valves 232 disposed between common channel 240 and a plurality of wells 230, and rotary membrane pump 251 connected to common channel 240.

In addition, in this fluid handling device 200, substrate 210 or film 220 has a structure for pulverizing an introduced sample at a position corresponding to rotary membrane pump 251. Examples of the structure for pulverizing the introduced sample include a roughened surface disposed on the surface of substrate 210 on the film 220 side at the position corresponding to rotary membrane pump 251, a plurality of protrusions disposed on the surface of substrate 210 on the film 220 side at the position corresponding to rotary membrane pump 251, a roughened surface disposed on the surface of film 220 on the substrate 210 side at the position corresponding to rotary membrane pump 251, a plurality of particles disposed between the first film and the second film constituting film 220 at the position corresponding to rotary membrane pump 251, and the like. One of these structures may be used alone or a plurality of the structures may be used in combination.

In the fluid handling device according to Embodiment 1, a sample (e.g., a formalin-fixed paraffin-embedded (FFPE) sample) is introduced into rotary membrane pump 251 from well 230 connected to rotary membrane pump 251. In this state, second rotary member 120 rotates to bring substrate 210 and film 220 into contact with each other at rotary membrane pump 251, whereby the sample between them is pulverized. For example, DNA is extracted from the pulverized sample.

Well 230 through which the sample is introduced and introduction channel 231 between well 230 and rotary membrane pump 251 are configured to be capable of receiving the sample. The cross-sectional size of introduction channel 231 is not particularly limited as long as introduction channel 231 is capable of receiving the sample, and the cross section has, for example, a rectangular shape with each side of a length equal to or greater than 1 mm.

According to fluid handling device 200 according to Embodiment 1, it is possible to pulverize the sample at rotary membrane pump 251

### Embodiment 2

A description will be given of Embodiment 2 that is fluid handling device 200 having a function of removing blood cells from an introduced blood sample.

As described above, fluid handling device 200 according to Embodiment 2 includes common channel 240, a plurality of wells 230 connected to common channel 240, a plurality of rotary membrane valves 232 disposed between common channel 240 and a plurality of wells 230, and rotary membrane pump 251 connected to common channel 240.

Further, this fluid handling device 200 includes well 230 for introducing a blood sample or a filter for separating blood cells that is disposed between well 230 for introducing the blood sample and rotary membrane valve 232 corresponding to this well 230. The filter provided makes it possible for the fluid handling device according to Embodiment 2 to separate the blood cells and thus analyze plasma components. In particular, it is useful, for example, for analyzing cell-free DNA existing in plasma.

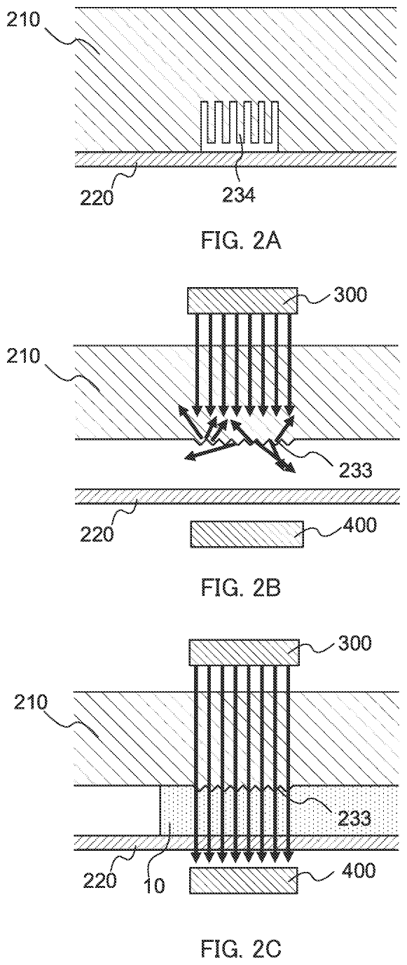

The configuration of the filter is not particularly limited as long as the filter is impermeable to blood cells and permeable only to plasma. For example, the filter may be a plurality of protrusions disposed on the surface of substrate 210 on the film 220 side in a channel between well 230 for introducing the blood sample and rotary membrane valve 232 corresponding to this well 230. FIG. 2A is a cross-sectional view of the channel including a plurality of protrusions 234 as the filter. The size and position of each of protrusions 234 are appropriately adjusted to exert a filter function.

It is preferable that fluid handling device 200 according to Embodiment 2 include a liquid surface detection section that is disposed downstream of the filter and at which arrival of a liquid surface is sensed by an external device. By sensing the arrival of the liquid surface at the liquid surface detection section, it is possible to detect clogging of the filter obstructing the flow of the liquid. FIGS. 2B and 2C illustrate an example of the liquid surface detection section. As illustrated in FIGS. 2B and 2C, the liquid detection section includes roughened surface 233 disposed on substrate 210. Light irradiator 300 and light sensor 400 that are an external device are disposed to sandwich roughened surface 233. As illustrated in FIG. 2B, when liquid 10 is not present in the channel, the light from light irradiator 300 is diffusely reflected by roughened surface 233, and is thus unlikely to reach light sensor 400. On the other hand, as illustrated in FIG. 2C, when liquid 10 is present in the channel, the light from light irradiator 300 is not reflected by roughened surface 233, and easily reaches light sensor 400. Accordingly, it is possible to detect whether or not liquid 10 in the channel arrives at the liquid surface detection section.

According to fluid handling device 200 according to Embodiment 2, it is possible to separate blood cells by using the filter and to allow only plasma to flow through the channel.

### Embodiment 3

A description will be given of Embodiment 3 that is fluid handling device 200 having a function of performing electrophoresis of a sample.

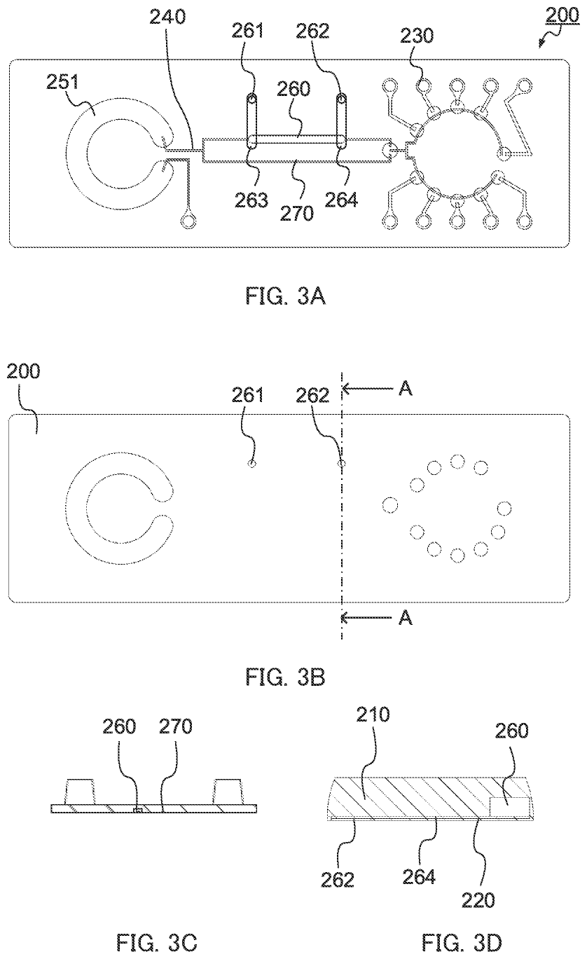

FIG. 3A schematically illustrates a configuration of fluid handling device 200 according to Embodiment 3, FIG. 3B is a bottom view of fluid handling device 200, FIG. 3C is a cross-sectional view taken along line A-A in FIG. 3B, and FIG. 3D is a partially enlarged view of FIG. 3C.

As described above, fluid handling device 200 according to Embodiment 3 includes common channel 240, a plurality of wells 230 connected to common channel 240, a plurality of rotary membrane valves 232 disposed between common channel 240 and a plurality of wells 230, and rotary membrane pump 251 connected to common channel 240.

Further, this fluid handling device 200 includes gel 260 and a pair of electrodes (anode 263 and cathode 264) for performing electrophoresis. In the present embodiment, as illustrated in FIG. 3A, gel 260 is disposed in one of channels branched from the common channel (described later). In addition, the pair of electrodes (anode 263 and cathode 264) are disposed to be capable of applying a voltage to gel 260. Anode 263 is disposed to be exposed at one end to the outside from anode connection port 261 provided in film 220 and exposed at the other end to the inside of the channel in which gel 260 is disposed. Cathode 264 is disposed to be exposed at one end to the outside from cathode connection port 262 provided in film 220 and exposed at the other end to the inside of the channel in which gel 260 is disposed (see FIG. 3D).

It is preferable that the depth and width of the channel filled with gel 260 be greater than the depth and width of a channel connected to the channel filled with gel 260. Thus, the volume of gel 260 can be increased as illustrated in FIGS. 3A to 3D.

When electrophoresis is performed, for example, a solution containing a nucleic acid may be delivered under pressure so that the nucleic acid enters the inside of gel 260, and then a voltage may be applied.

As illustrated in FIG. 3A, fluid handling device 200 according to Embodiment 3 may include side channel 270 that is placed side by side with the channel in which gel 260 is disposed. The liquid delivery under pneumatic pressure through the channel in which gel 260 is disposed causes a large pressure loss. Thus, side channel 270 disposed facilitates liquid delivery between rotary membrane pump 251 and well 230.

While the example has been described above in which a space between substrate 210 and film 220 is filled with gel 260, a space between the first film and the second film constituting film 220 may also be filled with gel 260. In this case, two through holes that function respectively as a gel inlet and a gel outlet are formed in one of the first film and the second film facing the channel. A sample flowing through the channel is applied a voltage upon arrival at the gel inlet, moves through the gel, and then arrives at the gel outlet. The arrival of the sample at gel 260 may be sensed, for example, with the configuration illustrated in FIGS. 2B and 2C described above.

According to fluid handling device 200 according to Embodiment 3, it is possible to perform electrophoresis of a sample.

### Embodiment 4

A description will be given of Embodiment 4 that is fluid handling device 200 capable of performing fluorescence detection on a sample.

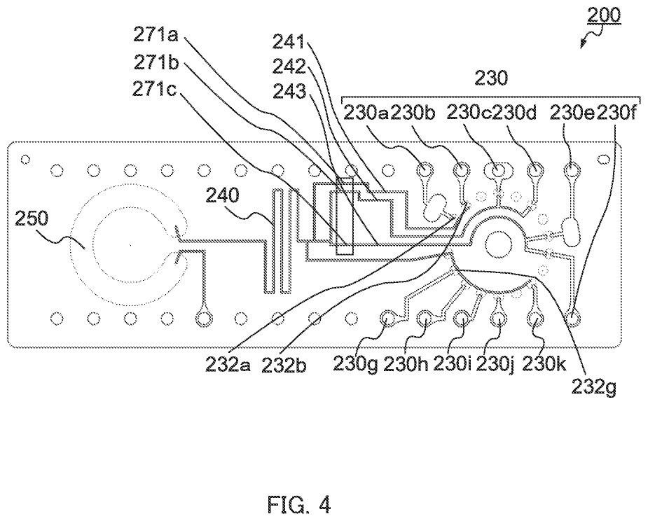

FIG. 4 schematically illustrates a configuration of fluid handling device 200 according to Embodiment 4.

As described above, fluid handling device 200 according to Embodiment 4 includes common channel 240, a plurality of wells 230 connected to common channel 240, a plurality of rotary membrane valves 232 disposed between common channel 240 and a plurality of wells 230, and rotary membrane pump 251 connected to common channel 240.

In addition, in this fluid handling device 200, the channel includes fluorescence detection sections 271 (271a to 271c) that are a space for accommodating a fluid on which detection of fluorescence is performed. In fluorescence detection sections 271 (271a to 271c), detection of fluorescence emitted from the fluid in the channel is performed using an external fluorescence detection device. In order to increase the fluorescence intensity to improve the detection sensitivity, the depth of fluorescence detection sections 271 (271a to 271c) is greater than the depth of a portion of the channel other than fluorescence detection sections 271 (271a to 271c). For example, the depth of fluorescence detection sections 271 (271a to 271c) can be increased by deepening grooves for forming fluorescence detection sections 271 (271a to 271c) that are formed in substrate 210 or by expanding film 220 forming fluorescence detection sections 271 (271a to 271c) to the side opposite to substrate 210. The widths of fluorescence detection sections 271 (271a to 271c) may be the same as or different from the width of the portion of the channel other than fluorescence detection sections 271 (271a to 271c). In the present embodiment, the widths of fluorescence detection sections 271 (271a to 271c) are the same as the width of the portion of the channel other than fluorescence detection sections 271 (271a to 271c).

As illustrated in FIG. 4, in the present embodiment, fluid handling device 200 includes wells 230a to 230f. Wells 230a and 230b, wells 230c and 230d, and wells 230e and 230f respectively form pairs: there are a total of three pairs of wells. Thus, a total of three samples can be handled. Note that, rotary membrane valves 232 are disposed for wells 230a to 230f, respectively.

Further, wells 230a and 230b are connected to common channel 240 via common first channel 241. Similarly, wells 230c and 230d are connected to common channel 240 via common second channel 242. Wells 230e and 230f are connected to common channel 240 via common third channel 243. First channel 241 includes first fluorescence detection section 271a, second channel 242 includes second fluorescence detection section 271b, and third channel 243 includes third fluorescence detection section 271c. As illustrated in FIG. 4, first fluorescence detection section 271a, second fluorescence detection section 271b, and third fluorescence detection section 271c are disposed close to one another. Thus, fluorescence detection in each of the channels can be performed using a single fluorescence detection device.

Further, fluid handling device 200 also includes wells 230g to 230k. A reagent for reaction with a sample, for example, is introduced into wells 230g to 230k. Note that, as described above, rotary membrane valves 232 are disposed for wells 230g to 230k, respectively.

For example, the sample is introduced into well 230a, only valve 232a is opened, and the sample is caused to move to a position in front of common channel 240 by rotary membrane pump 251. Next, only valve 232g is opened, and the reagent is caused to move to common channel 240 by rotary membrane pump 251.

Then, only valve 232b is opened, and the reagent having moved to common channel 240 is caused to move toward well 230b by rotary membrane pump 251. It is thus possible to mix the sample and the reagent in well 230b. After the mixture and reaction, the reaction liquid may be moved to fluorescence detection section 271 (first fluorescence detection section 271a) for detection of fluorescence.

Like well 230a and well 230b described above, the pair of well 230c and well 230d and the pair of well 230e and well 230f are capable of handling respective different samples: a total of three samples can be handled.

According to fluid handling device 200 according to Embodiment 4, it is possible to perform fluorescence detection on a plurality of samples.

### Embodiment 5

A description will be given of Embodiment 5 that is fluid handling device 200 capable of fractionating a liquid into a trace amount of fractions will be described.

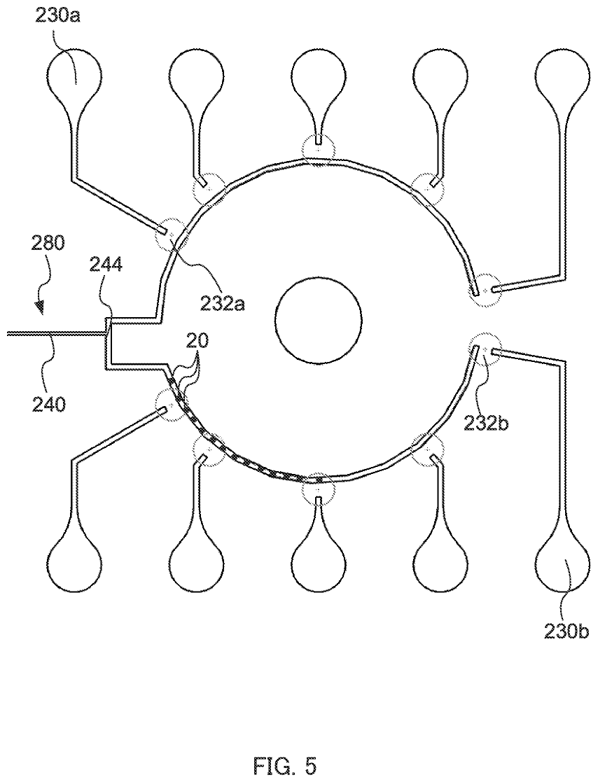

FIG. 5 is a partially enlarged schematic view illustrating a configuration of fluid handling device 200 according to Embodiment 5.

As described above, fluid handling device 200 according to Embodiment 5 includes common channel 240, a plurality of wells 230 connected to common channel 240, a plurality of rotary membrane valves 232 disposed between common channel 240 and a plurality of wells 230, and rotary membrane pump 251 connected to common channel 240.

Further, in fluid handling device 200, as illustrated in FIG. 5, common channel 240 includes branch portion 244 and liquid surface detection section 280 that is disposed at a predetermined distance from branch portion 244 and at which arrival of the liquid surface is sensed. A space between the branch portion and liquid surface detection section 280 functions as a measurement section for fractionating the liquid. From the viewpoint that a minute amount of liquid is to be fractionated, the cross-sectional area of a portion of the channel between the branch portion and liquid surface detection section 280 is smaller than the cross-sectional area of a portion of the channel not situated between the branch portion and liquid surface detection section 280. The configuration of liquid surface detection section 280 is, for example, the configuration illustrated in FIGS. 2B and 2C described above.

Measurement of a trace amount of liquid, e.g., at a level of pL and fractionation of the liquid with fluid handling device 200 according to Embodiment 5 will be described below with reference to FIG. 5.

To begin with, a sample is introduced into well 230a, valve 232a is opened, and the sample is caused to move to liquid surface detection section 280 of common channel 240 by rotary membrane pump 251. The position of the liquid surface of the sample may be detected by the mechanism illustrated in FIGS. 2B and 2C described above.

Here, since the space between the branch portion and liquid surface detection section 280 is narrow, an amount of sample on the order of picoliters, for example, can exist in this space.

Next, valve 232a is closed, and only valve 232b is opened, so that the sample existing in common channel 240 moves toward well 230b by rotary membrane pump 251. Accordingly, fractions 20 of the sample on the order of picoliters are obtained in the channel toward well 230b.

Repeating the above procedure results in multiple fractions 20 of the sample on the order of picoliters as illustrated in FIG. 5. Note that such fractionation is useful for digital PCR and the like.

According to fluid handling device 200 according to Embodiment 5, it is possible to fractionate a sample into a trace amount of fractions.

### Embodiment 6

A description will be given of Embodiment 6 that is fluid handling device 200 capable of culturing bacteria and the like.

As described above, fluid handling device 200 according to Embodiment 6 includes common channel 240, a plurality of wells 230 connected to common channel 240, a plurality of rotary membrane valves 232 disposed between common channel 240 and a plurality of wells 230, and rotary membrane pump 251 connected to common channel 240.

Fluid handling device 200 according to Embodiment 6 includes an agar medium disposed between substrate 210 and film 220 at rotary membrane pump 251. The agar medium may be disposed in a groove formed in substrate 210 or may be disposed thinly on substrate 210. The type of agar medium is not particularly limited and may be appropriately selected depending on a cultured target.

According to fluid handling device 200 of Embodiment 6, it is possible to culture bacteria by introducing a bacterial suspension from well 230 connected to rotary membrane pump 251, and applying the introduced bacterial suspension onto the agar medium using second rotary member 120.

### Embodiment 7

A description will be given of Embodiment 7 that is fluid handling device 200 capable of immobilization of an antibody or the like.

As described above, fluid handling device 200 according to Embodiment 7 includes common channel 240, a plurality of wells 230 connected to common channel 240, a plurality of rotary membrane valves 232 disposed between common channel 240 and a plurality of wells 230, and rotary membrane pump 251 connected to common channel 240.

In fluid handling device 200 according to Embodiment 7, a surface of substrate 210 exposed in the channel or the wells or a surface of film 220 exposed in the channel or the wells has an immobilization surface for immobilization of an antibody or an antigen. When substrate 210 is provided with the immobilization surface, the surface physical properties of the immobilization surface of substrate 210 are different from the surface physical properties of a surface of substrate 210 other than the immobilization surface. In addition, when film 220 is provided with the immobilization surface, the surface physical properties of the immobilization surface of film 220 are different from the surface physical properties of a surface of film 220 other than the immobilization surface. For example, the immobilization surface has surface physical properties allowing easier fixation of an antibody or an antigen, and the surface other than the immobilization surface has surface physical properties allowing a liquid to flow easily.

There is no particular limitation on a method of making the surface physical properties of the immobilization surface different from those of the other surface. For example, substrate 210 or film 220 may be partially masked and subjected to various treatments. In addition, the first film and the second film having surface physical properties different between the first and the second films may be laminated, and through holes may be formed in one of the films on the substrate side, so that the film to be exposed in the channel or the wells may be different for each place.

According to fluid handling device 200 according to Embodiment 7, it is possible to immobilize an antibody or an antigen in fluid handling device 200, to perform detection using the antibody or the antigen.

### EFFECT

As described above, according to fluid handling devices 200 according to the embodiments of the present invention, it is possible to perform various processing. Fluid handling devices 200 according to the embodiments of the present invention can also be used for liquid processing in sample preparation for next generation sequencing (NGS) and for delivery of a liquid staining reagent for a culture medium and visualization in a cell assay.

### INDUSTRIAL APPLICABILITY

The fluid handling devices of the present invention are useful in various applications such as, for example, clinical tests, food tests, and environmental tests.

### REFERENCE SIGNS LIST

10 Liquid
20 Fraction of sample
100 Fluid handling system
110 First rotary member
111 Convex portion
120 Second rotary member
200 Fluid handling device
210 Substrate
220 Film
230 Well
231 Introduction channel
232 Rotary membrane valve
233 Roughened surface
234 Protrusion
240 Common channel
241 First channel
242 Second channel
243 Third channel
244 Branch portion
250 Diaphragm portion
251 Rotary membrane pump
260 Gel
261 Anode connection port
262 Cathode connection port
263 Anode
264 Cathode
270 Side channel
271 Fluorescence detection section
280 Liquid surface detection section
300 Light irradiator
400 Light sensor
CA1 First central axis
CA2 Second central axis

1. A fluid handling device that includes a substrate and a film bonded to the substrate and that is configured to process a fluid, the fluid handling device comprising:
a channel;
a well connected to the channel;
a rotary membrane valve disposed between the channel and the well;
a rotary membrane pump connected to the channel; and
a filter disposed in the well or between the well and the rotary membrane valve for separating a blood cell component.

2. The fluid handling device according to claim 1, wherein
the filter is a plurality of protrusions disposed on a surface of the substrate on the film side between the well and the rotary membrane valve.

3. A fluid handling device that includes a substrate and a film bonded to the substrate and that is configured to process a fluid, the fluid handling device comprising:
a channel;
a well connected to the channel;
a rotary membrane valve disposed between the channel and the well;
a rotary membrane pump connected to the channel;
a gel disposed in the channel; and
a pair of electrodes disposed to be capable of applying a voltage to the gel.

4. A fluid handling device that includes a substrate and a film bonded to the substrate and that is configured to process a fluid, the fluid handling device comprising:
a channel;
a well connected to the channel;
a rotary membrane valve disposed between the channel and the well; and
a rotary membrane pump connected to the channel, wherein
the channel includes a fluorescence detection section that is a space for accommodating the fluid on which detection of fluorescence is performed, and
the fluorescence detection section is deeper than a portion of the channel other than the fluorescence detection section.

5. The fluid handling device according to claim 4, wherein
a width of the fluorescence detection section is the same as a width of the portion of the channel other than the fluorescence detection section.

6. The fluid handling device according to claim 4, wherein
the fluid handling device includes a first well and a second well as the well,
the channel includes
a common channel connected to the rotary membrane pump,
a first channel connected to the first well and the common channel, and
a second channel connected to the second well and the common channel,
the first channel includes a first fluorescence detection section as the fluorescence detection section, and
the second channel includes a second fluorescence detection section as the fluorescence detection section.

7. A fluid handling device that includes a substrate and a film bonded to the substrate and that is configured to process a fluid, the fluid handling device comprising:
a channel;
a well connected to the channel;
a rotary membrane valve disposed between the channel and the well; and
a rotary membrane pump connected to the channel, wherein
the channel includes
a branch portion and
a liquid surface detection section that is disposed at a predetermined distance from the branch portion and at which arrival of a liquid surface is sensed, and
a cross-sectional area of a portion of the channel between the branch portion and the liquid surface detection section is smaller than a cross-sectional area of a portion of the channel not situated between the branch portion and the liquid surface detection section.

8. A fluid handling device that includes a substrate and a film bonded to the substrate and that is configured to process a fluid, the fluid handling device comprising:
a channel;
a well connected to the channel;
a rotary membrane valve disposed between the channel and the well; and
a rotary membrane pump connected to the channel, wherein
a surface of the substrate exposed in the channel or the well or a surface of the film exposed in the channel or the well includes an immobilization surface for immobilization of an antibody or an antigen, and
the immobilization surface of the substrate or the film has a surface physical property different from that of a surface other than the immobilization surface.
